(19) United States
(12) Patent Application Publication
(10) Pub. No.: US 2026/0060784 A1
(43) Pub. Date: Mar. 5, 2026

(54) INVISIBLE DENTAL BRACE WITH PRESSURE-SENSITIVE SENSORS

(71) Applicant: 3D GLOBAL BIOTECH INC., New Taipei City (TW)

(72) Inventor: Keng-Liang OU, Taipei City (TW)

(73) Assignee: 3D GLOBAL BIOTECH INC., New Taipei City (TW)

(21) Appl. No.: 19/379,299

(22) Filed: Nov. 4, 2025

Related U.S. Application Data
(63) Continuation-in-part of application No. 18/532,774, filed on Dec. 7, 2023.
(60) Provisional application No. 63/431,324, filed on Dec. 9, 2022.

(51) Int. Cl. A61C 7/08; A61C 7/00; A61C 7/30

(52) U.S. Cl. CPC A61C 7/08; A61C 7/002; A61C 7/303

(57) ABSTRACT

The invention relates to an invisible dental brace with pressure-sensitive sensors, including: a brace body, at least one pressure-sensitive sensor, a processor, and a brace health monitoring module. The brace body is designed to be attached to at least one corresponding tooth of an orthodontic patient and reposition the at least one corresponding tooth from an initial position towards a target position according to a prescribed orthodontic treatment plan. The at least one pressure-sensitive sensor is configured to generate a sensor signal related to the wearing time of the brace body and a force or pressure applied to the at least one corresponding tooth by the brace body. The sensor signal is then transmitted to a cloud database for further analysis or to the processor for processing to generate a performance of the brace body. Finally, the performance is transmitted to a cloud database for an orthodontic practitioner to modify the prescribed orthodontic treatment plan.

### CROSS-REFERENCE TO RELATED APPLICATIONS

This application is a continuation-in part of U.S. patent application Ser. No. 18/532,774, filed on Dec. 7, 2023, the entire contents of which are incorporated herein by reference in its entirety.

### TECHNICAL FIELD

The present invention relates to the field of dental braces, and more particularly to invisible dental braces with pressure-sensitive sensors for monitoring and recording the wearing condition of an orthodontic patient to help the orthodontic practitioner to determine the causes of the ineffectiveness during the orthodontic treatment.

### BACKGROUND OF THE INVENTION

A large portion of the population has teeth that are misaligned in a manner considered improper for medical or aesthetic reasons, a condition generally referred to as malocclusion. To solve this problem, orthodontic treatment attempts to correct malocclusions and/or improve aesthetics by properly aligning the teeth. Commonly, orthodontic appliances such as dental braces, shell aligners, and the like are applied to the patient's teeth by an orthodontic practitioner to properly align the teeth. The dental braces can be configured to exert force on the teeth of an orthodontic patient to achieve desired tooth movements according to a prescribed plan of orthodontic treatment.

Recently, with the development in the field of material engineering and rapid prototyping techniques, invisible dental braces have been developed and are widely accepted between orthodontic patients and orthodontic practitioners for several reasons, including: free of dietary restriction, invisible appearance, and more comfortable and less pain.

Despite the obvious benefits of the invisible dental brace, if the process of orthodontic treatment is not as effective as expected, the orthodontic practitioner is unable to determine whether it is caused by the failure of the invisible dental brace or by the intermittent wearing conditions of the orthodontic patients.

Therefore, there is an indispensable need for developing a method to monitor the wearing condition of the invisible dental brace used by the orthodontic patient. However, practically the forces applied to a patient's teeth by an invisible dental brace may differ from the desired forces for the prescribed treatment plan and may result in incomplete or undesirable tooth movements. In other words, the amount and duration of the force applied by the invisible dental brace must be controlled and monitored throughout the orthodontic treatment to avoid undesirable effects, such as tooth root resorption, alveolar bone remodeling, and pain or discomfort caused by the invisible dental brace.

Accordingly, inventors of the present application have made a tremendous effort to make inventive research and eventually provide an invisible dental brace with pressure-sensitive sensors for monitoring and recording the performance of the invisible dental brace and the wearing condition of an orthodontic patient to help the orthodontic practitioner to determine the causes of the ineffectiveness or failure during the orthodontic treatment.

### SUMMARY OF THE INVENTION

The objective of the present invention is to disclose an invisible dental brace with pressure-sensitive sensors, including a brace body, at least one pressure-sensitive sensor, a processor, and a brace health monitoring module. The brace body is designed to comprise at least one cavity for being attached to at least one corresponding tooth of an orthodontic patient and repositioning the at least one corresponding tooth from an initial position towards a target position according to an prescribed plan of orthodontic treatment. The at least one pressure-sensitive sensor is arranged on a buccal and/or lingual side of the at least one cavity, i.e., the at least one pressure-sensitive sensor is attached to the wall on the buccal and/or lingual side of the at least one cavity. Moreover, the at least one pressure-sensitive sensor is configured to generate a sensor signal related to the wearing time of the brace body and a force or pressure applied to the at least one corresponding tooth of an orthodontic patient by the brace body. The processor is electrically connected to the at least one pressure-sensitive sensor and is configured to receive, store, and process the sensor signal. In addition, the sensor signal can either be transmitted directly from the at least one pressure-sensitive sensor to a cloud database for further analysis or be transmitted to the processor for processing to evaluate the performance and health status of the brace body. The performance of the brace body generated by the processor is then transferred to a cloud database for an orthodontic practitioner to adjust an prescribed plan of orthodontic treatment.

For achieving the prime objective mentioned above, the present invention provides an embodiment of an invisible dental brace with pressure-sensitive sensors, including:
a brace body including at least one cavity for being attached to at least one corresponding tooth of an orthodontic patient and repositioning the at least one corresponding tooth from an initial position towards a target position according to a prescribed plan of orthodontic treatment;
at least one pressure-sensitive sensor arranged on a buccal and/or lingual side of the at least one cavity, wherein the at least one pressure-sensitive sensor is configured to generate a sensor signal related to the wearing time of the brace body and a force or pressure exerted at the interface between an inner wall of each cavity of the brace body and each tooth of the at least one corresponding tooth, and configured to transmit the sensor signal wirelessly to a cloud database for further analysis and for an orthodontic practitioner to modify the prescribed plan of orthodontic treatment;
a processor, coupled to the brace body and configured to receive, store, and process the sensor signal, wherein the processor generates a performance of the brace body based on the sensor signal and transmits the performance wirelessly to the cloud database for an orthodontic practitioner to modify the prescribed plan of orthodontic treatment; and
a brace health monitoring module, having signal connection to or embedded in at least one of the processor and the cloud database, the brace health monitoring module analyzing the sensor signal to evaluate a health status of the invisible dental brace and/or the brace body, wherein the health status is determined by at least one of operational integrity, calibration accuracy, and moisture ingress status of the pressure-sensitive sensor, and the health status of the brace body is determined by at least one of capacitance drift, and signal output drift of the pressure-sensitive sensor, wherein when the health status of the pressure-sensitive sensor and/or the brace body falls outside a predetermined acceptable range, a health alert is generated.

In one embodiment, the operational integrity is determined by continuity of an electrical circuit inside the pressure-sensitive sensor, output stability of the sensor signal, and the responsiveness of the sensor to the force or pressure. The calibration accuracy of the pressure-sensitive sensor is evaluated by comparing a factory-measured zero-offset value obtained during initial calibration of the sensor when the brace body is not worn and a sensitivity coefficient derived from the pressure-sensitive sensor in-use during sensing the pressure with stored factory calibration parameters, wherein when the comparison difference exceeds a predetermined threshold, issuing a calibration alert. The moisture ingress status of the pressure-sensitive sensor is determined by monitoring variations in at least one of electrical impedance and high-frequency signal noise of the electrical circuit, and wherein when the moisture ingress status is determined, a moisture ingress alert is generated.

In one embodiment, the capacitance drift is determined by detecting abnormal capacitance increase, abnormal capacitance decrease, or capacitance fluctuation of the pressure-sensitive sensor. The signal output drift is determined based on a baseline signal output of the pressure-sensitive sensor measured in the absence of external pressure, and a variation in a sensitivity coefficient of the pressure-sensitive sensor, wherein when a structural degradation, structural deformation, or moisture ingress of the brace body is determined, an unhealthy brace body alert is generated.

In one embodiment, the invisible dental brace with pressure-sensitive sensors further includes a power source, memory and wireless communication circuit. The power source may be a flexible, thin and/or printed battery, such as a zinc-carbon flexible battery, a zinc-manganese dioxide printed flexible battery, or a solid-state thin-film lithium phosphorus oxynitride battery, for providing power to the at least one pressure-sensitive sensor and the processor. The usage of a flexible, thin and/or printed battery is beneficial for reducing the overall size of the invisible dental brace with pressure-sensitive sensors. Furthermore, the memory may be used to store the sensor signal and the performance generated, respectively, by the at least one pressure-sensitive sensor and the processor. The memory includes RAM such as SRAM or DRAM; ROM such as EPROM, PROM, or MROM; or hybrid memory such as EEPROM, flash, or NVRAM.

In one embodiment, the at least one pressure-sensitive sensor may be a force-sensitive sensor and includes a force-sensitive film, a pressure-sensitive film, a resistive film, a capacitive film or a piezoresistive pressure sensor.

In another embodiment, the at least one pressure-sensitive sensor is configured directly transmit the sensor signal to a cloud database wirelessly by the wireless communication circuit to a cloud database through any existing wireless communication technology for further analysis, wherein the wireless communication technology, includes WiFi, Bluetooth, WiMax, and cellular network.

In a further embodiment, the sensor signal further includes tooth movement data, tooth position data or tooth identification data, and the processor is configured to evaluate the performance of the brace body by using the sensor signal generated by and received from the at least one pressure-sensitive sensor.

In another further embodiment, the performance determined and evaluated by the processor is then transmitted wirelessly by the wireless communication circuit to a cloud database through any existing wireless communication technology, wherein the wireless communication technology includes WiFi, Bluetooth, WiMax or cellular network.

In addition, the cloud database can be a remote device of any computing device or system, such as a personal computer, laptop, tablet, mobile device, wearable device, etc.

In another perspective of the present invention, an invisible dental brace system for tooth repositioning is provided. The invisible dental brace system includes: an archwire and a brace body. The brace body includes plural pairs of base portions and brackets, wherein the base portion is designed to securely attach to one of the patient's teeth; the bracket is connected to the base portion of the same pair through a hinge or an elastic structure so as to allow minor disposition adjustment at an interface between the bracket and base portion; and the brackets are interconnected by an archwire configured to adjust a position and angulation of at least one of the patient's teeth. In one embodiment, the invisible dental brace system includes: an archwire and a brace body, at least one pressure-sensitive sensor, a processor, and a brace health monitoring module. The pressure-sensitive sensor generates a sensor signal related to wearing time of the brace body and a force or pressure between the brace body and the patient's teeth. The pressure-sensitive sensor is arranged at an interface between the base portion and the bracket, or between the base portion and the bracket, wherein the pressure-sensitive sensor is configured to transmit the sensor signal wirelessly to a cloud database for further analysis and for an orthodontic practitioner to modify an orthodontic treatment. The processor is coupled to the brace body and configured to receive, store, and process the sensor signal, wherein the processor generates a performance of the brace body based on the sensor signal and transmits the performance wirelessly to the cloud database for an orthodontic practitioner to modify the prescribed plan of orthodontic treatment. The brace health monitoring module has a signal connection to or embedded in at least one of the processor and the cloud database. The brace health monitoring module analyzes the sensor signal to evaluate a health status of the pressure-sensitive sensor and/or the brace body. The health status of the pressure-sensitive sensor is determined by at least one of operational integrity, calibration accuracy, and moisture ingress status of the pressure-sensitive sensor. The health status of the brace body is determined by at least one of capacitance drift, and signal output drift of the pressure-sensitive sensor, wherein when the health status of the pressure-sensitive sensor and/or the brace body falls outside a predetermined acceptable range, a health alert is generated.

### BRIEF DESCRIPTION OF THE DRAWINGS

The invention, as well as a preferred mode of use and advantages thereof, will be best understood by referring to the following detailed description of an illustrative embodiment in conjunction with the accompanying drawings, wherein: FIG. 1 is a schematic illustration of an invisible dental brace with a pressure-sensitive sensor according to an embodiment of the present invention;

FIGS. 1A and 1B are schematic illustrations of different dispositions for the health monitoring modules according to two embodiments of the present invention;

FIG. 2 is a schematic illustration of an invisible dental brace with a pressure-sensitive sensor worn by an orthodontic patient according to an embodiment of the present invention;

FIG. 3 is a schematic illustration of a sensor signal transmitted from a pressure-sensitive sensor to a cloud database;

FIG. 4 shows a flowchart of a method of orthodontic treatment using an invisible dental brace with pressure-sensitive sensors according to the present invention;

FIG. 5 is a schematic illustration of an invisible dental brace system according to an embodiment of the present invention;

FIGS. 6A, 6B, 6C, and 6D are schematic illustrations of brackets and base portions according to several embodiment of the present invention;

### DETAILED DESCRIPTION OF THE PREFERRED EMBODIMENTS

To better illustrate the advantages of the invisible dental brace with pressure-sensitive sensors according to the present invention and its contributions to the art, preferred embodiments of the present invention will be described in detail concerning the attached drawings hereafter.

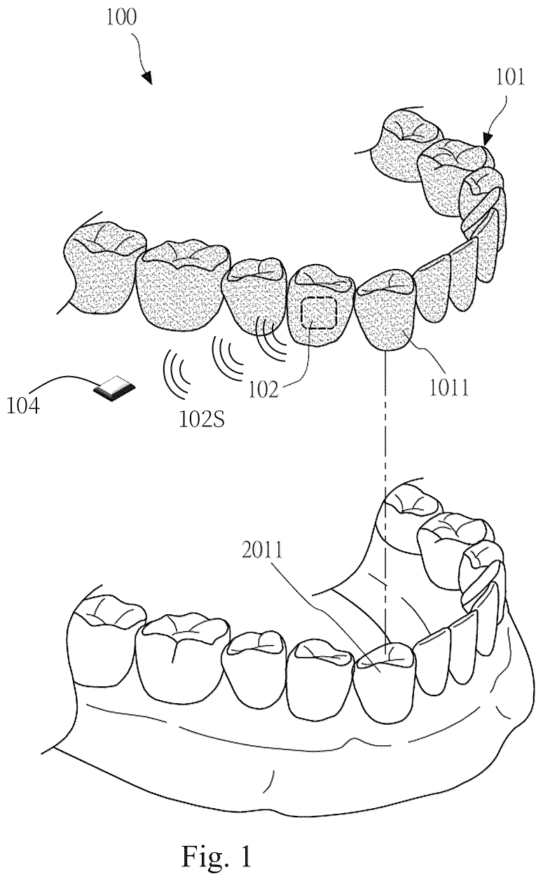

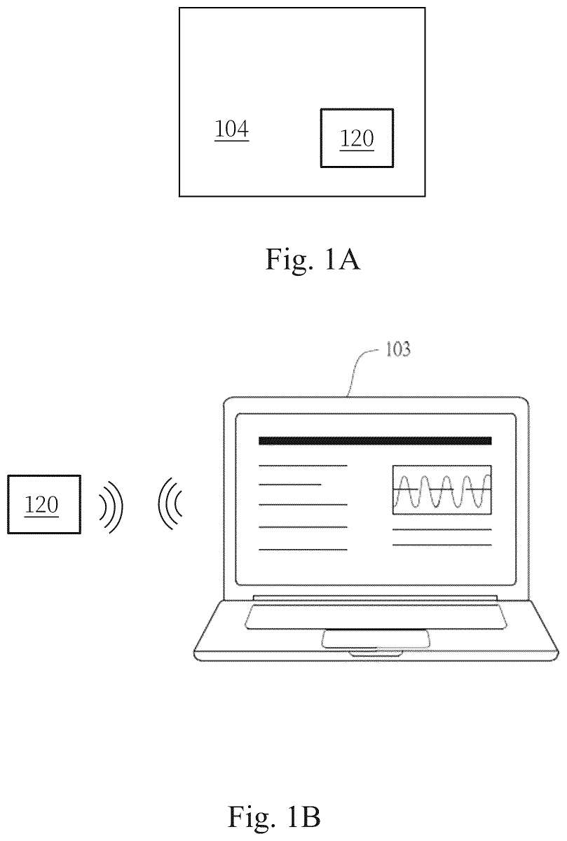

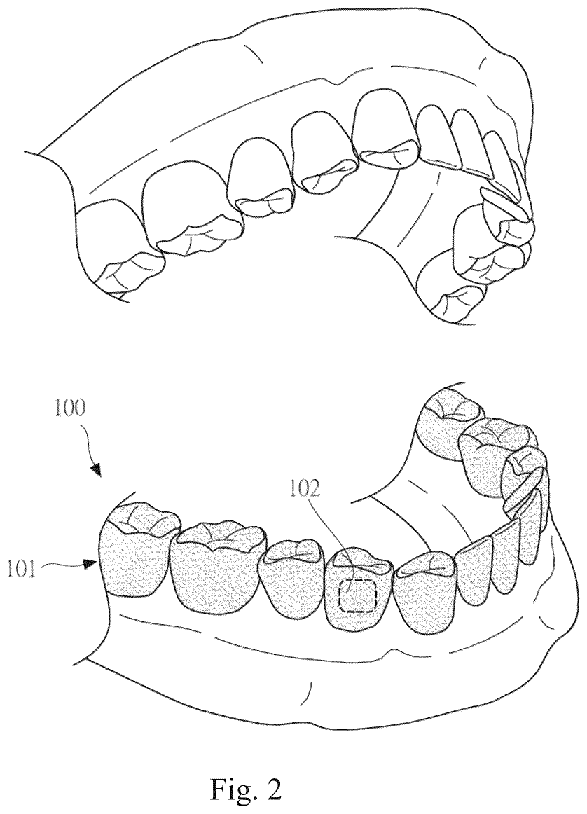

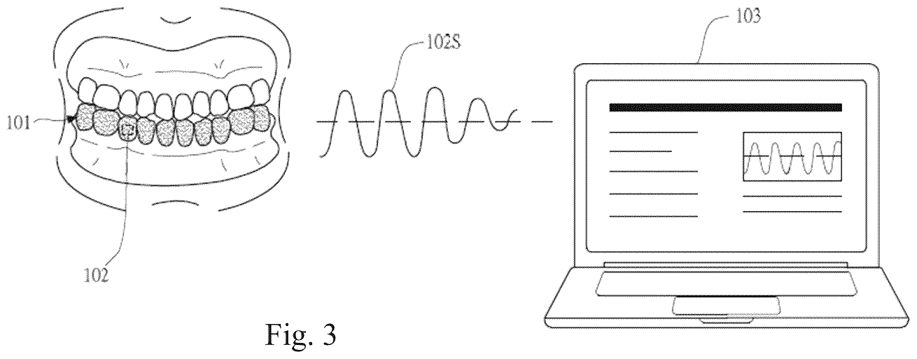

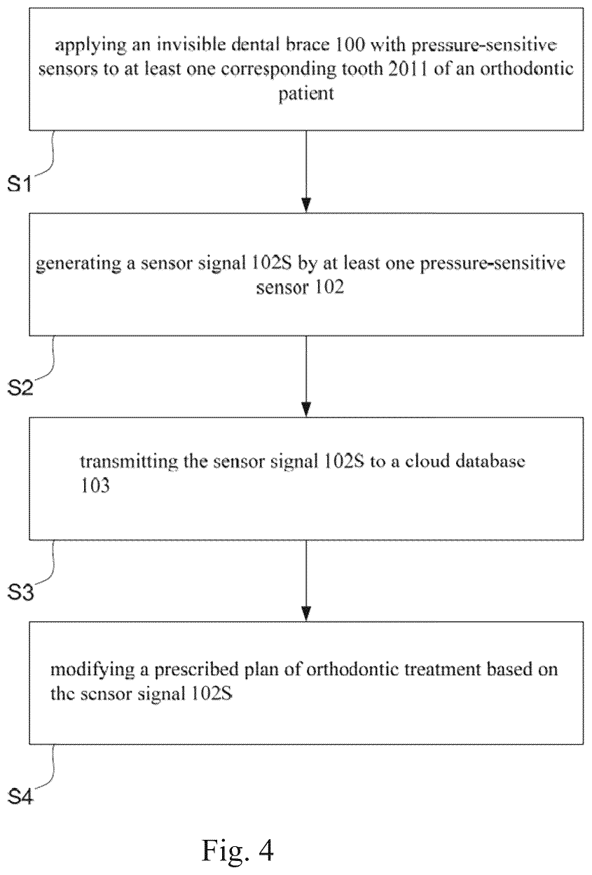

FIG. 1 is an illustrative schematic diagram that shows an invisible dental brace with a pressure-sensitive sensor according to the present invention, wherein the pressure-sensitive sensor is attached to the wall on the buccal side of one of the cavities of a brace body. FIG. 2 illustrates the brace body with a pressure-sensitive sensor worn by an orthodontic patient according to the present invention. FIG. 3 shows a sensor signal generated by a pressure-sensitive sensor is transmitted wirelessly from a pressure-sensitive sensor to a cloud database. FIG. 4 shows a flowchart of an orthodontic treatment using an invisible dental brace with pressure-sensitive sensors according to the present invention.

According to FIG. 1 and FIG. 2, an invisible dental brace 100 with pressure-sensitive sensors 102 includes a brace body 101 and at least one pressure-sensitive sensor 102. The brace body 101 is designed to comprise at least one cavity 1011 for being attached to at least one corresponding tooth 2011 of an orthodontic patient and repositioning the at least one corresponding tooth 2011 from an initial position towards a target position according to a prescribed plan of orthodontic treatment. The at least one pressure-sensitive sensor 102 is arranged on a buccal and/or lingual side of the at least one cavity 1011. In other words, the at least one pressure-sensitive sensor 102 is attached to the wall on the buccal and/or lingual side of the at least one cavity 1011. In FIG. 2, the exemplary embodiment shows that the invisible dental brace 100 with pressure-sensitive sensors 102 is worn in the bottom row of teeth, and the at least one pressure-sensitive sensor 102 is arranged on a buccal side of the at least one cavity 1011.

According to FIG. 3, the at least one pressure-sensitive sensor 102 is configured to generate a sensor signal 102S related to the wearing time of the brace body 101, and a force or pressure exerted at the interface between an inner wall of each cavity 1011 of the brace body 101 and a surface of the corresponding tooth 2011 of an orthodontic patient by the brace body 101. Then the sensor signal 102S generated by the at least one pressure-sensitive sensor 102 can be transmitted wirelessly from the at least one pressure-sensitive sensor 102 to a cloud database 103 for further analysis by an orthodontic practitioner to modify the prescribed plan of orthodontic treatment.

In one embodiment, the invisible dental brace 100 with a pressure-sensitive sensor 102 according to the present invention can further comprise a processor 104. The processor is electrically connected or has a signal connection to the at least one pressure-sensitive sensor 102 and is configured to receive, store, and process the sensor signal 102S generated by the at least one pressure-sensitive sensor 102. After the processor 104 received the sensor signal 102S, the sensor signal 102S is processed by the processor 104 to produce a performance of the brace body 101 and then the performance is transmitted wirelessly to a cloud database 103 for an orthodontic practitioner to adjust the prescribed plan of orthodontic treatment.

In other words, the sensor signal 102S can either be transmitted directly from the at least one pressure-sensitive sensor 102 to a cloud database 103 for further analysis or be transmitted to the processor 104 for processing to evaluate the performance of the brace body 101.

In one embodiment, the sensor signal 102S includes tooth movement data, tooth position data or tooth identification data and can be transmitted wirelessly to a cloud database 103 through any existing wireless communication technology, wherein the wireless communication technology includes WiFi, Bluetooth, WiMax or cellular network. In addition, the cloud database 103 can be a remote device of any computing device or system, such as a personal computer, laptop, tablet, mobile device, wearable device, etc.

In one embodiment, the invisible dental brace 100 may include a brace health monitoring module 120, having signal connection to or embedded in at least one of the processor 104 (FIG. 1A) and the cloud database 103 (FIG. 1B), the brace health monitoring module 120 analyzing the sensor signal 102S to evaluate a health status of the pressure-sensitive sensor 102 and/or the brace body 101, wherein the health status of the pressure-sensitive sensor 102 is determined by at least one of operational integrity, calibration accuracy, and moisture ingress status of the pressure-sensitive sensor 102, and the health status of the brace body 101 is determined by at least one of capacitance drift, and signal output drift of the pressure-sensitive sensor 102, wherein when the health status of the pressure-sensitive sensor 102 and/or the brace body 101 falls outside a predetermined acceptable range, a health alert is generated.

In one embodiment, the operational integrity is determined by at least one of the continuity of an electrical circuit (not shown) inside the pressure-sensitive sensor 102, the output stability of the sensor signal 102S, and the responsiveness of the sensor to the force or pressure. The calibration accuracy of the pressure-sensitive sensor 102 is evaluated by comparing a factory-measured zero-offset value obtained during initial calibration of the sensor when the brace body 101 is not worn and a sensitivity coefficient derived from the pressure-sensitive sensor 102 in-use during sensing the pressure with stored factory calibration parameters, wherein when the comparison difference exceeds a predetermined threshold, issuing a calibration alert. The moisture ingress status of the pressure-sensitive sensor 102 is determined by detected variations in at least one of electrical impedance and high-frequency signal noise of the electrical circuit, and wherein when the moisture ingress status is determined, a moisture ingress alert is generated.

The operational integrity of the pressure-sensitive sensor 102 is determined by three key indicators: (1) the continuity of the electrical circuit within the pressure-sensitive sensor 102, (2) the output stability of the sensor signal 102S, and (3) the responsiveness of the sensor to an applied force or pressure. The electrical continuity test verifies that the conductive paths inside the sensor remain intact without open or short circuits. The output stability assessment monitors whether the pressure-sensitive sensor 102 provides a consistent baseline signal over time under constant environmental and mechanical conditions. The responsiveness test evaluates the dynamic reaction of the pressure-sensitive sensor 102 when the applied orthodontic force varies, ensuring that the output signal amplitude and response time fall within a defined operational range. A degradation in any of these parameters may indicate a structural failure or aging of the sensing element.

A conversion equation between the measured sensor voltage and applied pressure is: P=a (V_{S}−V₀)+b, wherein P is the applied pressure, V_{S} is the measured sensor voltage, V₀ is the zero-offset voltage, and a and b are calibration coefficients. The calibration accuracy of the pressure-sensitive sensor 102 is evaluated by comparing a zero-offset value (V₀), measured by the factory when the brace body 101 is not worn, with a sensitivity coefficient (a) derived from the sensor's in-use pressure signal relationship during operation. These two measured values are compared against stored factory calibration parameters representing the reference performance of the sensor under standard conditions. When the difference between the measured and reference parameters exceeds a predetermined threshold, the system identifies a potential calibration drift and automatically issues a calibration alert. This process ensures that the data transmitted to the processor 104 or cloud database accurately reflects the true mechanical force applied to the patient's teeth.

The moisture ingress status of the pressure-sensitive sensor 102 is determined by continuously monitoring variations in at least one of the electrical impedance or high-frequency signal noise of the sensor's electrical circuit. An increase in impedance instability or noise amplitude indicates the possible presence of water or saliva infiltration, which can alter the dielectric constant of the encapsulating layer or create unintended conductive paths within the sensor. When the system detects a moisture-related exception that exceeds a predefined tolerance limit, a moisture ingress alert is generated and transmitted to the processor 104 or cloud database.

In one embodiment, the health condition of the brace body 101 is monitored through analysis of capacitance drift and signal output drift of the pressure-sensitive sensor 102. These electrical characteristics provide indirect yet reliable indicators of structural changes, material degradation, or environmental effects within the brace body 101 surrounding the sensor.

The capacitance drift is determined by detecting abnormal capacitance increase, abnormal capacitance decrease, or capacitance fluctuation of the pressure-sensitive sensor 102. The signal output drift is determined based on a baseline signal output of the pressure-sensitive sensor 102 measured in the absence of external pressure, and a variation in a sensitivity coefficient of the pressure-sensitive sensor 102, wherein when a structural degradation, structural deformation, or moisture ingress of the brace body 101 is determined, an unhealthy brace body alert is generated.

Under normal operating conditions, the capacitance remains stable because the geometry of the sensor and the dielectric constant of the encapsulating material are constant and stable. However, when the brace body 101 experiences mechanical deformation, aging, or material fatigue, the distance between the sensor electrodes or the dielectric constant of the surrounding material may change, thereby resulting in detectable capacitance variation. Specifically, an abnormal capacitance increase may indicate moisture absorption or water penetration that raises the effective dielectric constant, whereas a capacitance decrease may suggest the formation of microcracks, delamination, or air gaps inside the brace body 101. Random or irregular capacitance fluctuations often imply material instability or partial detachment of the sensor from the inner wall of the brace cavity.

The baseline signal output is the real-time, continuously measured reference level under a “no-load” or “steady” condition during normal operation., while the sensitivity coefficient defines the proportionality between applied force and output signal. When the baseline signal output gradually shifts or the sensitivity coefficient changes beyond a defined tolerance, the processor 104 interprets such behavior as a sign of structural degradation, deformation, or moisture ingress within the brace body 101 that alters stress distribution or material stiffness.

The brace health monitoring module offers several advantages that enhance the performance and reliability of invisible dental brace:

First, it enables real-time diagnostic evaluation of both the pressure-sensitive sensors and the brace body, allowing early detection of malfunction, calibration drift, or moisture intrusion before they significantly affect treatment accuracy.

Second, by analyzing parameters such as operational integrity, capacitance drift, and signal output stability, the module provides predictive maintenance capability, helping clinicians identify potential failures and replace defective aligners or sensors in advance.

Third, integration with the processor or cloud database can enable automated data logging and intelligent feedback, supporting adaptive treatment adjustments and remote monitoring by orthodontic practitioners.

Finally, the module improves treatment safety and consistency, ensuring that orthodontic forces remain within prescribed plan while reducing the need for frequent in-office inspections. Collectively, these features improve durability, data reliability, and clinical efficiency of the overall dental brace system.

In a further embodiment, the invisible dental brace 100 with pressure-sensitive sensors 102 may comprise a power source and memory (not shown). The power source may be a flexible, thin and/or printed battery, such as a zinc-carbon flexible battery, a zinc-manganese dioxide printed flexible battery, or a solid-state thin-film lithium phosphorus oxynitride battery, for providing power to the at least one pressure-sensitive sensor 102 and the processor 104. The usage of a flexible, thin and/or printed battery is advantageous for reducing the overall size of the invisible dental brace 100 with pressure-sensitive sensors 102. Furthermore, the memory may be used to store the sensor signal 102S and the performance generated respectively by the at least one pressure-sensitive sensor 102 and the processor 104. The memory includes RAM such as SRAM or DRAM; ROM such as EPROM, PROM, or MROM; or hybrid memory such as EEPROM, flash, or NVRAM.

According to FIG. 4, a method of orthodontic treatment using an invisible dental brace 100 with pressure-sensitive sensors according to the present invention includes the following steps:
S1: applying an invisible dental brace 100 with pressure-sensitive sensors to at least one corresponding tooth 2011 of an orthodontic patient;
S2: generating a sensor signal 102S associated with the wearing time of the brace body 101, a force or pressure applied to the at least one corresponding tooth 2011 of the orthodontic patient, tooth movement data, tooth position data or tooth identification data by at least one pressure-sensitive sensor 102;
S3: transmitting the sensor signal 102S to a cloud database 103 from the at least one pressure-sensitive sensor 102 for further analysis; and
S4: modifying a prescribed plan of orthodontic treatment based on the sensor signals 102S.

In a nutshell type design, the above descriptions have thoroughly introduced the invisible dental brace with pressure-sensitive sensors 102 according to the present invention. The above descriptions are made on embodiments of the present invention; however, the embodiments are not intended to limit the scope of the present invention, and all equivalent implementations or alterations within the spirit of the present invention still fall within the scope of the present invention.

For another embodiment, the brace body 101 is made from a transparent material (for example, plastic material of polycarbonate PC or PEEK) and the pressure-sensitive sensors 102 are strategically placed within the brace body 101 to detect the pressure exerted by the teeth during movement.

Wherein the brace body 101 is made from a transparent material that blends seamlessly with the natural color of the teeth. The pressure-sensitive sensors 102 are capable of accurately measuring the force applied to the teeth. The processor is integrated into the brace body 101 and the processor is wirelessly connected to an external device.

The processor analyzes the data collected by the pressure-sensitive sensors 102 to determine the effectiveness of the orthodontic treatment and provides recommendations for adjustments if necessary. The recommendations for adjustments are communicated to the user and the orthodontist.

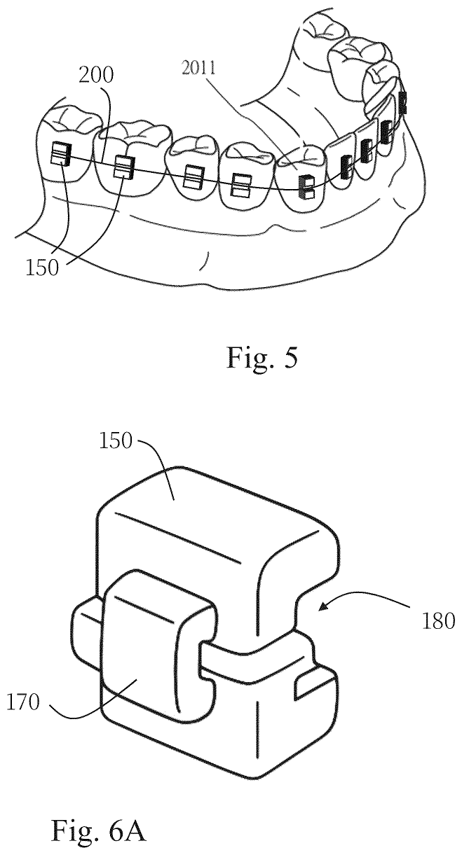

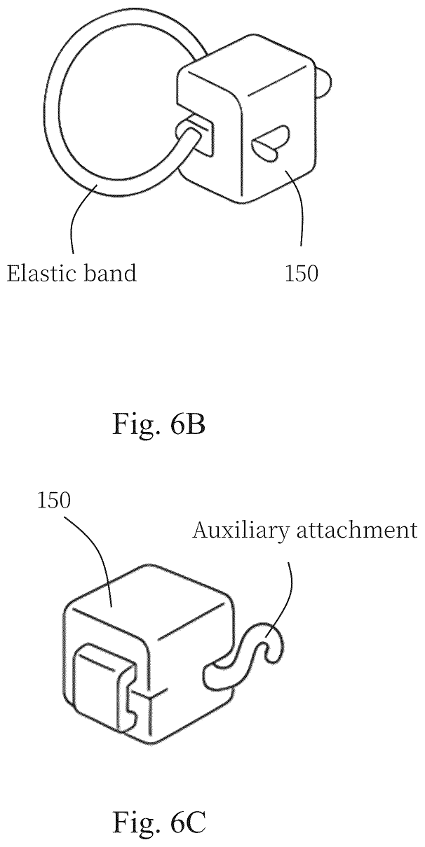

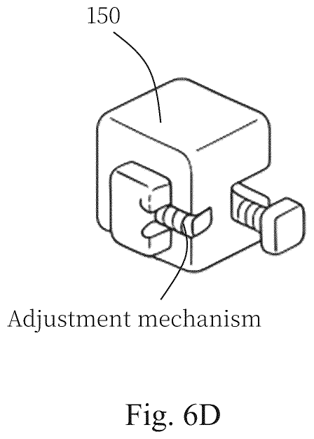

In another perspective of the present invention, as shown in FIG. 5, an invisible dental brace system for tooth repositioning, including: an archwire 200, and a brace body 101 including plural pairs of brackets 150 and base portions 170 being securely attached to one of the patient's teeth 2011 (FIG. 6A). The brace body 101 includes plural pairs of brackets 150 and base portions 170 being securely attached to one of the patient's teeth, the bracket being connected to the base portion 170 of the same pair through a hinge or an elastic structure so as to allow minor disposition adjustment at an interface between the bracket and base portion, the brackets being interconnected by the archwire 200 configured to adjust a position and angulation of at least one of the patient's teeth.

Each base portion 170 is configured to be securely attached to the surface of one of the patient's teeth 2011 by an adhesive or equivalent fixing material. The base portion 170 provides a stable foundation for supporting orthodontic components and ensures firm attachment throughout the treatment period without interfering with oral hygiene or patient comfort.

Each bracket 150 of the same pair is mechanically connected to the corresponding base portion 170 through a hinge or an elastic structure (not shown), allowing fine adjustment of its position and orientation. This hinge or elastic connection serves as a compliant joint that enables the bracket to slightly pivot or flex relative to the base portion 170. Such micro-adjustability facilitates more precise tooth movement control by compensating for variations in tooth morphology, bonding angle, or individual patient exception. The hinge connection can be implemented as a miniaturized mechanical linkage, while the elastic structure may include a flexible polymer element or a spring-like member that provides controlled deformation under orthodontic force.

The brackets 150 are interconnected by the archwire 200 extending across multiple teeth, the archwire 200 being configured to apply a corrective force to adjust both the position and angulation of at least one of the patient's teeth. The archwire 200 exerts a continuous and controlled orthodontic load that interacts with the adjustable brackets, translating mechanical energy into tooth movement along the desired path defined by the orthodontic treatment plan.

This configuration enhances the adaptability and precision of the orthodontic system by allowing localized adjustment at each bracket-tooth interface, thereby reducing the need for frequent archwire replacements or manual repositioning. The combination of hinged or elastic coupling and an interconnected archwire 200 provides an effective balance between rigidity for stable force transmission and flexibility for dynamic alignment correction. Consequently, the system improves treatment efficiency, patient comfort, and overall alignment accuracy compared with conventional fixed braces.

Each bracket 150 further includes a slot 180 for receiving a wire or archwire 200 (FIGS. 5 and 6A). The brackets 150 are adjustably connected to the base portion 170, allowing for controlled tooth movement. In FIG. 5, there is a engaging portion to engage the archwire to each of the brackets 105, there are various methods for receiving and securing the archwire within the slot, such as different types of locking mechanisms or engagement features, the present invention does not claim the specific techniques for receiving or securing the archwire. The technique for receiving and securing the archwire is not shown in figure. Instead, the emphasis is on the adjustable connection of the brackets to the base portion, which enables controlled tooth movement.

In one embodiment, invisible dental brace system further includes at least one pressure-sensitive sensor, a processor, and a brace health monitoring module.

In the bracket-type orthodontic brace, the pressure-sensitive sensors are strategically positioned to monitor the forces transmitted between the brackets, archwire, and tooth surface. Each bracket is mounted on the base portion securely bonded to the patient's tooth, and the pressure-sensitive sensor is typically embedded within or attached to the interface between the bracket and the base portion. This placement allows the sensor to directly detect the compressive or tensile forces exerted by the archwire as it interacts with the bracket slot and transfers corrective pressure to the tooth.

As per the signal connection between the pressure-sensitive sensor, the processor, and the cloud database, please refer to the aforementioned embodiments. The detail is not elaborated herein.

In one embodiment, the invisible dental brace system further includes a plurality of elastic bands for connecting the brackets to the base portion 170 (FIG. 6B), providing additional force for tooth repositioning, for assisting the connection between the brackets to the base portion 170, allowing for customized tooth movement, a plurality of adjustment mechanisms for fine-tuning the tooth movement, and a plurality of indicators for monitoring the progress of tooth repositioning.

The elastic band for orthodontic application is a small, stretchable component used to apply continuous corrective forces between brackets, teeth, or jaws. It is typically made of medical-grade elastomer or polymer and can be configured in various diameters and tension levels depending on treatment requirements. During operation, the elastic band is hooked between designated brackets or attachments on opposite teeth or arches. When stretched, the band stores elastic potential energy that is gradually released as a gentle, continuous pulling force. This force helps to reposition teeth, close/narrow gaps, or adjust bite alignment over time. The orthodontist periodically replaces or repositions the bands to maintain optimal tension as tooth positions change.

As shown in FIG. 6C, the auxiliary attachment in the invisible dental brace can be a structural or mechanical component designed to enable precise control of tooth movement by allowing minor modification of the applied orthodontic force or bracket position. The auxiliary attachments comprise hooks, loops, or clips for receiving additional orthodontic appliances.

As shown in FIG. 6D, the adjustment mechanism may include screws, springs, or ratchets that are integrated into the bracket or archwire assembly. When activated, either manually by the orthodontist or automatically through tension balancing, the mechanism alters the distance, angle, or tension between the brackets and the archwire 200. For example, a screw-type mechanism can incrementally tighten or loosen to change the torque applied to a specific tooth, while a spring-loaded mechanism maintains continuous pressure to achieve gradual repositioning. A ratchet-based mechanism allows stepwise locking of the desired position for stable correction. These mechanisms provide fine-tuning capability for tooth alignment, improving treatment precision and reducing adjustment intervals, thus enhancing both efficiency and patient comfort during orthodontic correction.

A pressure-sensitive sensor is a sensor that can measure pressure. Common pressure-sensitive sensors 102 include strain gauges, capacitive sensors, optical sensors, and magnetostrictive sensors. The pressure-sensitive sensor can be used to monitor the force or pressure applied by the orthodontic appliance to the teeth. The sensor should have the following characteristics: high sensitivity, which can accurately measure small changes in pressure; good stability, which can be used for a long time without failure; high reliability, which can ensure normal operation in harsh environments.

A processor is an electronic device that can receive, store, and process data. In my invention, the processor can be used to receive, store, and process the sensor signals generated by the pressure-sensitive sensor. The processor should have the following characteristics: strong computational ability, which can quickly process complex data; large storage capacity, which can store a large amount of data; low power consumption, which can extend battery life.

A wireless communication circuit is an electronic device that can wirelessly transmit data. In my invention, the wireless communication circuit can be used to transmit the data generated by the processor to the cloud database. The wireless communication circuit should have the following characteristics: Long communication distance, which can cover a larger area; fast transmission speed, which can quickly transmit a large amount of data; Strong anti-interference ability, which can work normally in harsh environments.

A power supply is a device that can provide power to electronic devices. In my invention, the power supply can be used to power the pressure-sensitive sensor, processor, and wireless communication circuit. The power supply should have the following characteristics: high power density, which can provide enough power for electronic devices; long life, which can be used for a long time without damage; safe and reliable, which can prevent battery explosions or fires.

Memory is an electronic device that can store data. In my invention, the memory can be used to store the data generated by the pressure-sensitive sensor, processor, and wireless communication circuit. The memory should have the following characteristics: large capacity, which can store a large amount of data; ffast read and write speed, which can quickly read and write data; high reliability, which can ensure data security.

A cloud database is a database stored in the cloud. In my invention, the cloud database can be used to store the data generated by the processor. The cloud database should have the following characteristics: large capacity, which can store a large amount of data; high security, which can prevent data from being stolen or tampered with; good scalability, which can be expanded as the amount of data increases.

According to the above technical description, the present invention can be used in the following specific application scenarios:

Wearing time monitoring: It can be used to monitor whether the patient is wearing the orthodontic appliance according to the regulations. If the patient's wearing time is insufficient, the patient can be reminded to wear it in time.

Force monitoring: It can be used to monitor the force applied by the orthodontic appliance to the teeth. If the force is too large, the orthodontist can be reminded to adjust the design of the orthodontic appliance.

Orthodontic effect evaluation: It can be used to evaluate the orthodontic effect of the orthodontic appliance. If the orthodontic effect is not good, the orthodontist can be reminded to adjust the orthodontic treatment plan.

In aligners, pressure-sensitive sensors 102 are a key technology used to evaluate the impact of aligners on each tooth. The application and operation flow of this sensor can be described in detail as follows:
Step 1: Start of wear time: When the patient starts wearing aligners, the pressure-sensitive sensors also start working. They immediately sense the forces and pressures interacting with the teeth.
Step 2: Generation of sensor signals: The sensors start generating sensor signals related to the wearing time and the pressure applied to the teeth in each cavity. This could be a series of data points, representing the pressure status of each corresponding tooth over time.
Step 3: Connection to the processor: The generated sensor signals are transmitted to the processor, which is the electronic device connected to the sensors. This connection is typically achieved through flexible, thin, and/or printed circuits.
Step 4: Data storage: The processor stores these data in memory for subsequent processing and analysis. This helps to record the pressure status at each time point during the orthodontic process.
Step 5: Generation of performance: Based on the sensor data, the processor generates information about the performance of the aligners. This could include the degree of adjustment to each corresponding tooth, changes in pressure, and so on.
Step 6: Wireless transmission: The processor can wirelessly transmit these performance data to a cloud database through wireless communication circuits. Such transmission is typically real-time, enabling real-time monitoring of the treatment.

Data transmission process between pressure-sensitive sensors and cloud database: Data generation by pressure-sensitive sensors: Pressure-sensitive sensors sense changes in pressure interacting with the teeth, and generate data related to wearing time and the pressure applied to the teeth in each cavity in real time.

Data connection to processor: These data are connected to the processor, which is the device electrically connected to the sensors, through flexible, thin, and/or printed circuits.

Data analysis and performance data generation by processor: The processor analyzes sensor data and generates information about the performance of the aligners, such as the adjustment status of the teeth, changes in pressure, and so on.

Data storage: These performance data are stored in the memory of the processor, which could be RAM (SRAM or DRAM), ROM (EPROM, PROM, or MROM), or mixed memory (EEPROM, flash, or NVRAM).

Power supply: The operation of the processor and sensors requires a power supply. Flexible, thin, and/or printed batteries (such as zinc-carbon flexible batteries, zinc-manganese dioxide printed flexible batteries, or solid-state thin-film lithium-phosphorus-nitrogen oxide batteries) are typically used for this application, which helps to reduce overall size.

Wireless communication circuit: The processor is connected to a wireless communication circuit, which is implemented through technologies such as WiFi, Bluetooth, WiMax, or cellular networks. This part supports wireless data transmission.

Data transmission to cloud database: The wireless communication circuit transmits the performance data generated by the processor to the cloud database through the selected wireless technology. This could be real-time, enabling real-time monitoring of the treatment.

Cloud reception and storage: The cloud database receives and stores data from the processor. Such a cloud database could be a remote device, such as a personal computer, laptop, tablet, mobile device, and so on.

Further analysis and diagnosis: In the cloud, the data can be further analyzed, including analysis of tooth movement data, location data, or tooth identification data. This provides orthodontists with more information to assess the effectiveness of the aligners and make adjustments.

What is claimed is:

1. An invisible dental brace with pressure-sensitive sensors, including:
a brace body (101), including at least one cavity (1011) for being attached to at least one corresponding tooth (2011) of an orthodontic patient and repositioning the at least one corresponding tooth from an initial position towards a target position according to a prescribed plan of orthodontic treatment;
at least one pressure-sensitive sensor (102), arranged on a buccal and/or lingual side of the at least one cavity, wherein the at least one pressure-sensitive sensor is configured to generate a sensor signal related to wearing time of the brace body and a force or pressure produced between each cavity of said at least one cavity and each tooth of said at least one corresponding tooth (2011), and/or configured to transmit the sensor signal (102S) wirelessly to a cloud database (103) for further analysis and for an orthodontic practitioner to modify the orthodontic treatment;
a processor (104), coupled to the brace body (101) and configured to receive, store, and process the sensor signal (102S), wherein the processor generates a performance of the brace body (101) based on the sensor signal (102S) and transmits the performance wirelessly to the cloud database (103) for an orthodontic practitioner to modify the prescribed plan of orthodontic treatment; and
a brace health monitoring module (120), having signal connection to or embedded in at least one of the processor and the cloud database, the brace health monitoring module analyzing the sensor signal (102S) to evaluate a health status of the pressure-sensitive sensor and/or the brace body, wherein the health status of the pressure-sensitive sensor is determined by at least one of operational integrity, calibration accuracy, and moisture ingress status of the pressure-sensitive sensor (102), and the health status of the brace body is determined by at least one of capacitance drift, and signal output drift of the pressure-sensitive sensor, wherein when the health status of the pressure-sensitive sensor and/or the brace body falls outside a predetermined acceptable range, a health alert is generated.

2. The invisible dental brace of claim 1, wherein the operational integrity is determined by continuity of an electrical circuit inside the pressure-sensitive sensor, output stability of the sensor signal, and the responsiveness of the sensor to the force or pressure;
the calibration accuracy of the pressure-sensitive sensor is evaluated by comparing a factory-measured zero-offset value obtained during initial calibration of the sensor when the brace body is not worn and a sensitivity coefficient derived from the pressure-sensitive sensor in-use during sensing the pressure with stored factory calibration parameters, wherein when the comparison difference exceeds a predetermined threshold, issuing a calibration alert; and
the moisture ingress status of the pressure-sensitive sensor is determined by monitoring variations in at least one of electrical impedance and high-frequency signal noise of the electrical circuit, and wherein when the moisture ingress status is determined, a moisture ingress alert is generated.

3. The invisible dental brace of claim 1, wherein the capacitance drift is determined by detecting abnormal capacitance increase, abnormal capacitance decrease, or capacitance fluctuation of the pressure-sensitive sensor; and
the signal output drift is determined based on a baseline signal output of the pressure-sensitive sensor measured in the absence of external pressure, and a variation in a sensitivity coefficient of the pressure-sensitive sensor, wherein when a structural degradation, structural deformation, or moisture ingress of the brace body is determined, an unhealthy brace body alert is generated.

4. The invisible dental brace of claim 1, wherein the brace body is made from a transparent material, and the pressure-sensitive sensor(s) are strategically placed within the brace body to detect the pressure exerted by the teeth during movement.

5. The invisible dental brace of claim 4, wherein the pressure-sensitive sensors are capable of accurately measuring the force applied to the teeth.

6. The invisible dental brace of claim 4, wherein the processor is integrated into the brace body.

7. The invisible dental brace of claim 4, wherein the processor is wirelessly connected to an external device.

8. The invisible dental brace of claim 4, wherein the processor analyzes the data collected by the pressure-sensitive sensors to determine the effectiveness of the orthodontic treatment and provides recommendations for adjustments if necessary.

9. The invisible dental brace of claim 8, wherein the recommendations for adjustments are communicated to the user and the orthodontist.

10. An invisible dental brace system for tooth repositioning, including:
an archwire; and
a brace body, including plural pairs of brackets and base portions being securely attached to one of the patient's teeth, the bracket being connected to the base portion of the same pair through a hinge or an elastic structure so as to allow minor disposition adjustment at an interface between the bracket and base portion, the brackets being interconnected by the archwire configured to adjust a position and angulation of at least one of the patient's teeth.

11. The invisible dental brace system of claim 10, further including:
at least one pressure-sensitive sensor, generate a sensor signal related to wearing time of the brace body and a force or pressure between the brace body and the patient's teeth, the pressure-sensitive sensor arranged at an interface between the base portion and the bracket, or between the base portion and the bracket, wherein the pressure-sensitive sensor is configured to transmit the sensor signal wirelessly to a cloud database for further analysis and for an orthodontic practitioner to modify an orthodontic treatment;
a processor, coupled to the brace body and configured to receive, store, and process the sensor signal, wherein the processor generates a performance of the brace body based on the sensor signal and transmits the performance wirelessly to the cloud database for an orthodontic practitioner to modify the prescribed plan of orthodontic treatment; and
a brace health monitoring module, having signal connection to or embedded in at least one of the processor and the cloud database, the brace health monitoring module analyzing the sensor signal to evaluate a health status of the pressure-sensitive sensor and/or the brace body, wherein the health status of the pressure-sensitive sensor is determined by at least one of operational integrity, calibration accuracy, and moisture ingress status of the pressure-sensitive sensor, and the health status of the brace body is determined by at least one of capacitance drift, and signal output drift of the pressure-sensitive sensor, wherein when the health status of the pressure-sensitive sensor and/or the brace body falls outside a predetermined acceptable range, a health alert is generated.

12. The invisible dental brace system of claim 11, wherein the operational integrity is determined by continuity of an electrical circuit inside the pressure-sensitive sensor, output stability of the sensor signal, and the responsiveness of the sensor to the force or pressure;
the calibration accuracy of the pressure-sensitive sensor is evaluated by comparing a factory-measured zero-offset value obtained during initial calibration of the sensor when the brace body is not worn and a sensitivity coefficient derived from the pressure-sensitive sensor in-use during sensing the pressure with stored factory calibration parameters, wherein when the comparison difference exceeds a predetermined threshold, issuing a calibration alert; and
the moisture ingress status of the pressure-sensitive sensor is determined by monitoring variations in at least one of electrical impedance and high-frequency signal noise of the electrical circuit, and wherein when the moisture ingress status is determined, a moisture ingress alert is generated.

13. The invisible dental brace system of claim 12, wherein the capacitance drift is determined by detecting abnormal capacitance increase, abnormal capacitance decrease, or capacitance fluctuation of the pressure-sensitive sensor; and
the signal output drift is determined based on a baseline signal output of the pressure-sensitive sensor measured in the absence of external pressure, and a variation in a sensitivity coefficient of the pressure-sensitive sensor, wherein when a structural degradation, structural deformation, or moisture ingress of the brace body is determined, an unhealthy brace body alert is generated.

14. The invisible dental brace system of claim 10, wherein the brackets are adjustably connected to the base portion, allowing for controlled tooth movement.

15. The invisible dental brace system of claim 10, further including a plurality of elastic bands for connecting the brackets to the base portion, providing additional force for tooth repositioning.

16. The invisible dental brace system of claim 10, further including a plurality of adjustment mechanisms for fine-tuning the tooth movement.

17. The invisible dental brace system of claim 16, wherein the adjustment mechanisms comprise screws, springs, or ratchets.

18. The invisible dental brace system of claim 10, further including a plurality of indicators for monitoring the progress of tooth repositioning.
